(19) United States
(12) Patent Application Publication
(10) Pub. No.: US 2026/0180930 A1
(43) Pub. Date: Jun. 25, 2026

(54) INFORMATION PROCESSING SYSTEM, INFORMATION PROCESSING METHOD, AND TERMINAL APPARATUS

(71) Applicant: Genki WATANABE, Tokyo (JP)

(72) Inventor: Genki WATANABE, Tokyo (JP)

(21) Appl. No.: 19/417,408

(22) Filed: Dec. 12, 2025

(30) Foreign Application Priority Data
Dec. 19, 2024 (JP) 2024-223683
Sep. 12, 2025 (JP) 2025-152099

(51) Int. Cl. H04L 51/02; G06F 3/0482; G06F 16/958; G06F 40/143

(52) U.S. Cl. CPC H04L 51/02; G06F 3/0482; G06F 16/958; G06F 40/143

(57) ABSTRACT

An information processing system includes an information processing apparatus and a terminal apparatus. The information processing apparatus receives a message; transmits the message to AI; receives a response; causes information including the response to be displayed; registers the information; causes the information to be displayed as selectable; and transmits web content data for displaying a first web page for receiving the message and a second web page enabling selectable display of the information. The data includes a script that causes the terminal apparatus to transmit an information retrieval instruction and display the second page. The information processing apparatus reads the information in response to a request from the terminal apparatus and transmits a response including the information to cause the apparatus to display the second page. The terminal apparatus displays the first page, transmits the request, receives the response, and displays the second page.

### CROSS-REFERENCE TO RELATED APPLICATIONS

This patent application is based on and claims priority pursuant to 35 U.S.C. § 119(a) to Japanese Patent Application Nos. 2024-223683, filed on Dec. 19, 2024, and 2025-152099, filed on Sep. 12, 2025, in the Japan Patent Office, the entire disclosure of each of which is hereby incorporated by reference herein.

### BACKGROUND

### Technical Field

The present disclosure relates to an information processing system, an information processing method, and a terminal apparatus.

### Related Art

Artificial intelligence (AI) has been devised that automatically generates a response to a message such as a question from a user and outputs the response to interact with the user.

### SUMMARY

The present disclosure described herein provides an information processing system including an information processing apparatus and a terminal apparatus. The information processing apparatus includes processing circuitry that receives a message input by a user; transmits the received message to artificial intelligence (AI); receives a response generated by the AI to which the message has been transmitted; causes information including the response to be displayed; registers the information in a memory in response to a predetermined instruction input by the user for the information; causes one or more pieces of information, including the information including the response, registered in the memory to be displayed as selectable items in response to the message input by the user; and transmits to the terminal apparatus web content data for displaying a first web page including a screen for receiving input of the message from the user, and a second web page enabling selectable display of the one or more pieces of registered information. The web content data includes a script that causes the terminal apparatus to execute at least a process for transmitting an instruction to retrieve the one or more pieces of registered information to the information processing apparatus, the instruction being input on the first web page; and a process for displaying the second web page enabling the selectable display of the one or more pieces of registered information. The processing circuitry reads the one or more pieces of registered information in response to a HyperText Transfer Protocol (HTTP) request transmitted from the terminal apparatus executing the script and including the instruction to retrieve the one or more pieces of registered information. The instruction is input on the first web page displayed on the terminal apparatus based on the web content data. The processing circuitry transmits, as a response to the HTTP request, an HTTP response including the one or more pieces of registered information to the terminal apparatus to cause the terminal apparatus to execute the script and display the second web page. The terminal apparatus includes terminal circuitry that displays, on a display, the first web page including the screen for receiving the input of the message from the user; executes the script to transmit the HTTP request; receives the HTTP response; and displays, on the display, the second web page based on the one or more pieces of registered information included in the HTTP response.

The present disclosure described herein provides an information processing method including receiving a message input by a user; transmitting the received message to AI; receiving a response generated by the AI to which the message has been transmitted; causing information including the response to be displayed; registering the information in a memory in response to a predetermined instruction input by the user for the information; causing one or more pieces of information, including the information including the response, registered in the memory to be displayed as selectable in response to the message input by the user; and transmitting to a terminal apparatus web content data for displaying a first web page including a screen for receiving input of the message from the user, and a second web page enabling selectable display of the one or more pieces of registered information. The web content data includes a script that causes the terminal apparatus to execute at least a process for transmitting an instruction to retrieve the one or more pieces of registered information to the information processing apparatus, the instruction being input on the first web page; and a process for displaying the second web page enabling the selectable display of the one or more pieces of registered information. The method further includes reading the one or more pieces of registered information in response to an HTTP request transmitted from the terminal apparatus executing the script and including the instruction to retrieve the one or more pieces of registered information, the instruction being input on the first web page displayed on the terminal apparatus based on the web content data; and transmitting, as a response to the HTTP request, an HTTP response including the one or more pieces of registered information to the terminal apparatus to cause the terminal apparatus to execute the script and display the second web page.

The present disclosure described herein provides a terminal apparatus including circuitry that receives a message input by a user; displays, on a display, information including a response from AI to the received message; registers the information in a memory in response to a predetermined instruction input by the user for the information; and displays, on the display, one or more pieces of information, including the information including the response, registered in the memory as selectable items in response to the message input by the user.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing system;

FIG. 2 is a block diagram illustrating a hardware configuration of an information processing apparatus;

FIG. 3 is a block diagram illustrating a functional configuration of an information processing apparatus;

FIG. 4 is a sequence diagram of a process executed by an information processing system in a response registration phase;

FIG. 5 is a diagram illustrating an interactive screen;

FIG. 6 is a diagram illustrating a configuration of a history information storage unit;

FIG. 7 is a diagram illustrating response information as displayed;

FIG. 8 is a diagram illustrating a confirmation screen as displayed;

FIG. 9 is a diagram illustrating a configuration of a registered information storage unit;

FIG. 10 is a diagram illustrating grouping and hierarchization of registered information;

FIG. 11 is a sequence diagram of a process executed by an information processing system in a registered information utilization phase;

FIG. 12 is a diagram illustrating an interactive screen as displayed when one or more pieces of information are registered as registered information;

FIG. 13 is a diagram illustrating a selection screen as displayed;

FIG. 14 is a diagram illustrating an interactive screen to which a message is input after one or more pieces of registered information are selected;

FIG. 15 is a diagram illustrating a second example of the selection screen illustrated in FIG. 13;

FIG. 16 is a diagram illustrating a third example of the selection screen illustrated in FIG. 13;

FIG. 17 is a diagram illustrating a functional configuration of a terminal apparatus according to a second embodiment;

FIG. 18 is a sequence diagram of a process related to screen transition according to the second embodiment;

FIG. 19 is a diagram illustrating a first interactive screen as displayed, according to the second embodiment;

FIG. 20 is a diagram illustrating an interactive screen as displayed after a message is input;

FIG. 21 is a diagram illustrating an updated interactive screen according to the second embodiment; and

FIG. 22 is a diagram illustrating a functional configuration of a terminal apparatus having the functions of an information processing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

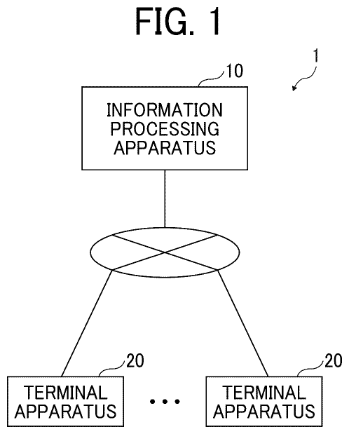

FIG. 1 is a diagram illustrating a configuration of an information processing system 1. In FIG. 1, one or more terminal apparatuses 20 are connected to an information processing apparatus 10 via a network such as a local area network (LAN) or the Internet.

The information processing apparatus 10 is implemented by one or more computers provided with software that interacts with a user. This software may be referred to as “agent a1” in the following description. The agent a1 is an anthropomorphic, virtual existence that appears to the user as a dialogue partner. Specifically, the agent a1 receives a message input by the user from the terminal apparatus 20, controls generation of a response to the message, and causes the response to be displayed on the terminal apparatus 20. The message input by the user may be a question, an instruction, a request, or any other input information that requires a response. The response is text that includes information corresponding to the message. The agent a1 may be referred to, for example, as automatic response means, an artificial intelligence (AI) agent, a digital clone, a personalized AI, an AI assistant, an automatic response AI, a dialogue partner, an AI chatbot, a companion, or a virtual interactive interface.

The terminal apparatus 20 is an apparatus that operates as a user interface of the information processing system 1. For example, the terminal apparatus 20 may be implemented by a personal computer (PC), a smartphone, or a tablet terminal apparatus. The terminal apparatus 20 receives input of a message from the user and transmits the message to the information processing apparatus 10. The terminal apparatus 20 also receives a response generated in response to the message from the information processing apparatus 10 and displays the response. The terminal apparatus 20 may output the received information, for example, through a projector.

In the present embodiment, it is assumed that the information processing system 1 is operated by a certain company, which may be referred to as “company X” in the following description. The user who can access the information processing apparatus 10 is a person belonging to the company X, such as an employee of the company X. The service provided by the information processing apparatus 10 may be open to the public as a cloud service.

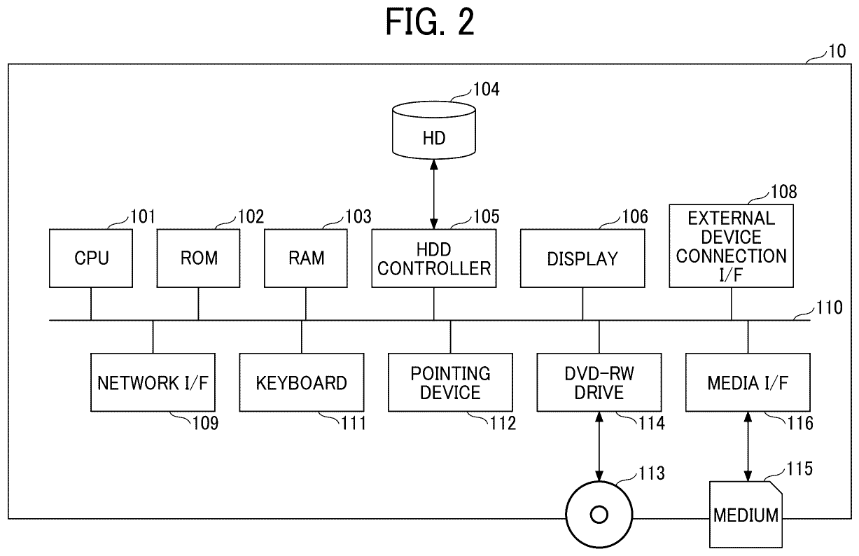

FIG. 2 is a block diagram illustrating a hardware configuration of the information processing apparatus 10. As illustrated in FIG. 2, the information processing apparatus 10 is implemented by a computer, and includes a central processing unit (CPU) 101, a read-only memory (ROM) 102, a random-access memory (RAM) 103, a hard disk (HD) 104, a hard disk drive (HDD) controller 105, a display 106, an external device connection interface (I/F) 108, a network I/F 109, a data bus 110, a keyboard 111, a pointing device 112, a digital versatile disk rewritable (DVD-RW) drive 114, and a media I/F 116.

The CPU 101 controls the overall operation of the information processing apparatus 10. The ROM 102 stores a program such as an initial program loader (IPL) used for booting the CPU 101. The RAM 103 is used as a work area for the CPU 101. The HD 104 stores various data such as a program. The HDD controller 105 controls the reading of various data from, or the writing of various data to, the HD 104 under the control of the CPU 101. The display 106 displays various types of information, such as a cursor, a menu, a window, text, or an image. The external device connection I/F 108 is an interface for connection with various external devices. Examples of the external devices in this case include, but are not limited to, a universal serial bus (USB) memory and a printer. The network I/F 109 is an interface for data communication through a communication network. The data bus 110 is, for example, an address bus or a data bus, which electrically connects the components or elements such as the CPU 101 illustrated in FIG. 2.

The keyboard 111 is an example of an input device provided with multiple keys for entering characters, numerical values, and various instructions. The pointing device 112 is another example of the input device that allows the user to select or execute a specific instruction, select a target for processing, or move a cursor being displayed. The DVD-RW drive 114 controls the reading of various data from, or the writing of various data to, a DVD-RW 113, which is an example of a removable recording medium. The removable storage medium is not limited to the DVD-RW and may be a DVD-recordable (DVD-R). The media I/F 116 controls the reading of data from, or the writing (storing) of data to (in), a recording medium 115 such as a flash memory.

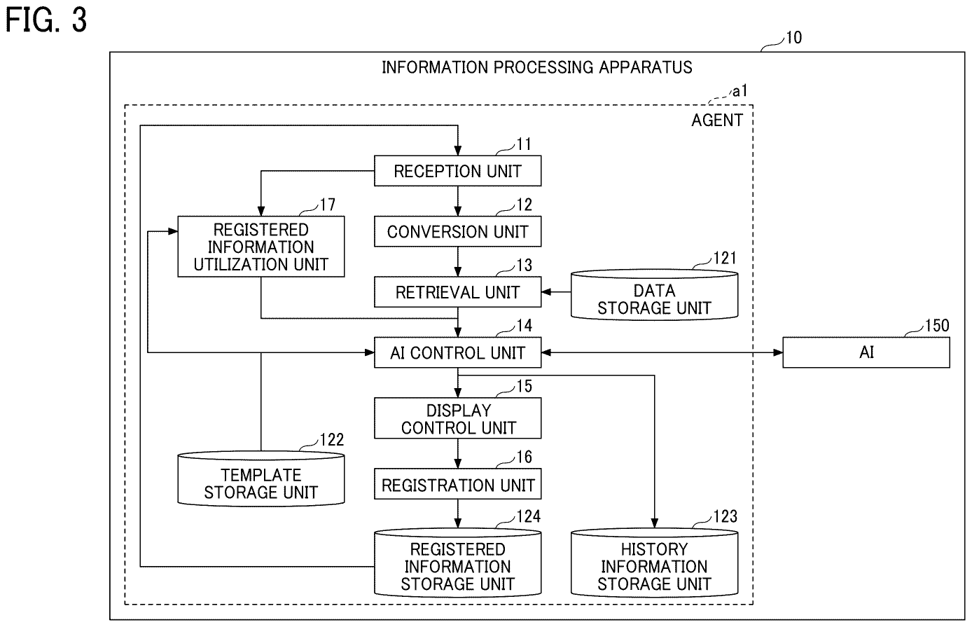

FIG. 3 is a block diagram illustrating a functional configuration of the information processing apparatus 10.

In FIG. 3, the information processing apparatus 10 includes AI 150 and the agent a1.

The AI 150 is a machine-learning model (for example, a neural network), which has been trained to generate text in response to input text. The text being generated may be referred to as a response, whereas the input text may be referred to as a prompt in the following description. For example, the AI 150 generates, as a response to the prompt, text having the highest occurrence probability based on the learning result. The AI 150 may be, for example, a generative AI using a large language model (LLM). The LLM is a machine learning model that has learned natural language processing using a large amount of text data. The LLM is used in many natural language processing (NLP) tasks, such as generation of responses to specific questions, automatic generation of sentences, summarization of text, translation, and emotion analysis. Further, the LLM may be used in various fields such as education, entertainment, customer service, and product development. In the present embodiment, the prompt is the text including the message input by the user. The AI 150 does not have to be operated on the information processing apparatus 10. For example, the AI 150 may be a generative AI that is open to the public, such as the one available on the Internet.

The machine learning is a technique for causing a computer to acquire human-like learning capability and refers to a technique in which a computer autonomously generates an algorithm necessary for determination of, for example, data identification from learning data imported in advance, and applies the algorithm to new data to perform prediction. Any suitable learning method is applied for machine learning, for example, any one of supervised learning, unsupervised learning, semi-supervised learning, reinforcement learning, and deep learning, or a combination of two or more of those learning.

The agent a1 is a set of functional units and storage units for executing processing for receiving a message from a user, generating a response by the AI 150 to the message using Retrieval-Augmented Generation (RAG), and including text (a response to a prompt) generated by the AI 150 in the past in a prompt. Specifically, the agent a1 includes, as the functional units, a reception unit 11, a conversion unit 12, a retrieval unit 13, an AI control unit 14, a display control unit 15, a registration unit 16, and a registered information utilization unit 17. These units are implemented by the CPU 101 that execute processes according to one or more programs installed on the information processing apparatus 10. The agent a1 also includes, as the storage units, a data storage unit 121, a template storage unit 122, a history information storage unit 123, and a registered information storage unit 124. These storage units may be each implemented by, for example, the HD 104 or a storage device that can be connected to the information processing apparatus 10 via a network.

The reception unit 11 receives inputs from the user. For example, the reception unit 11 receives a message input by a user. More specifically, the user input is performed on the terminal apparatus 20. The reception unit 11 thus receives information corresponding to the input, which is received by the terminal apparatus 20, from the terminal apparatus 20.

When the reception unit 11 receives a message, the conversion unit 12 converts the message into a vector that represents the meaning of the message by a multi-dimensional numerical value. This vector may be referred to as a “semantic vector” in the following description. The semantic vector may be generated using a natural language processing model, such as bidirectional encoder representations from transformers (BERT). The semantic vector that is generated by converting the message may be referred to as a “message vector” in the following description.

The retrieval unit 13 extracts a part of document data having a relatively high relevance to the message, from among units of document data stored in the data storage unit 121, using the message vector generated by the conversion unit 12. The data storage unit 121 previously stores document data related to various tasks of the company X. For example, the user may upload document data to the data storage unit 121 at any time. The data storage unit 121 stores, for each unit of such document data, the document data and a semantic vector for each chunk of the document data. The chunk refers to a part of the document data obtained by dividing the document data in a predetermined unit. The unit of dividing the document data may be defined by the number of characters, the number of sentences, or a semantic unit (for example, a paragraph), and is not limited to a predetermined unit. The semantic vector of each chunk may be referred to as a “chunk vector” in the following description. The retrieval unit 13 compares, for each unit of document data, the message vector with the chunk vector of each chunk relevant to the document data, and specifies a chunk corresponding to a chunk vector having the highest similarity to the document data. This chunk may be referred to as a “similar chunk” in the following description. The retrieval unit 13 compares the similarities of the similar chunks for each unit of document data and extracts the top N similar chunks having the highest similarities. As a result, the N units of document data are selected. To evaluate the similarity between the vectors, a cosine similarity may be used, or another index may be used. The retrieval unit 13 includes, in a retrieval result, related document information including the top N similar chunks, chunk identifications (IDs) stored in the data storage unit 121 in association with the similar chunks, and document IDs and file names stored in the data storage unit 121 in association with the document data to which the similar chunks belong. The file names may be referred to as document names in the following description.

The AI control unit 14 functions as an example of a transmission unit that generates a prompt including the message received by the reception unit 11 and a set of similar chunks relevant to the retrieval result by the retrieval unit 13 and transmits the prompt to the AI 150. The AI control unit 14 also functions as an example of a receiving unit that receives, from the AI 150, a response generated by the AI 150 to which the prompt has been transmitted.

The AI control unit 14 also functions as an example of a transmission unit that transmits a prompt generated by the registered information utilization unit 17 to the AI 150. In other words, the AI control unit 14 generates a prompt by augmenting the message received by the reception unit 11 with the set of similar chunks relevant to the retrieval result by the retrieval unit 13. Typical RAG may be used as a method for including the set of similar chunks relevant to the retrieval result in the prompt. The text of each chunk belonging to the set of similar chunks relevant to the retrieval result may be included in the prompt. Alternatively, a vector generated based on the chunk vector of the chunk may be included in the prompt. When generating the prompt, the AI control unit 14 uses a template of the prompt stored in the template storage unit 122. This template may be referred to as a “system prompt” in the following description. The system prompt includes explicitly defined sections for inserting a message and for inserting a set of similar chunks relevant to the retrieval result by the retrieval unit 13. The following is a simple example of the system prompt.
<Example of system prompt begins.>
The message from the user is as follows.
{Message}
Please generate a response to the message by referring to the following document.
{Set of similar chunks relevant to retrieval result}
<Example of system prompt ends.>

In this case, the AI control unit 14 generates a prompt by inserting the message received by the reception unit 11 to the {message} section of the system prompt and inserting the set of similar chunks relevant to the retrieval result by the retrieval unit 13 to the {set of similar chunks relevant to retrieval result} section of the system prompt. Inputting the prompt thus generated to the AI 150 allows the AI 150 to generate a response based on even the information included in the set of similar chunks relevant to the retrieval result, which includes information that the AI 150 has not learned. In other words, the response from the AI 150 may be based on the set of similar chunks relevant to the retrieval result.

Each time the AI control unit 14 receives a response from the AI 150, the AI control unit 14 stores a message that is the source of the response, the retrieval result, and the response in the history information storage unit 123 in association with each other. Accordingly, history information of interactions with the AI 150, including input into and output from the AI 150, is stored in the history information storage unit 123.

The display control unit 15 transmits display content to the terminal apparatus 20 to cause a screen to be displayed on the terminal apparatus 20. At this time, the terminal apparatus 20 displays a screen on the browser. The display control unit 15 also generates response information including the response received by the AI control unit 14, and causes the generated response information to be displayed on the terminal apparatus 20 that is the transmission source of the message. The response information includes not only the response but also information indicating document data to which each similar chunk relevant to the retrieval result by the retrieval unit 13 belongs.

Accordingly, the user can confirm what document data is used as a basis for generating the response.

When the user inputs a predetermined instruction for the response information displayed by the display control unit 15, the registration unit 16 registers the response information in the registered information storage unit 124 to enable selectable display of one or more pieces of response information when the user inputs a message later. The predetermined instruction is an instruction to receive a request for registration. Specifically, the predetermined instruction is an operation performed by the user on the terminal apparatus 20. For example, the operation is pressing a button on the screen. Instead of pressing the button, the user may input a message “Register this document” in a dialog. Alternatively, the user may press the button and input the chat message. The predetermined instruction may be a voice instruction. The registration unit 16 may register the entire response information in the registered information storage unit 124, or may register information relevant to a part, selected by the user, of the response information in the registered information storage unit 124. The information registered in the registered information storage unit 124 may be used when a new message is input. The information registered in the registered information storage unit 124 may be referred to as “registered information” in the following description. The registration unit 16 also hierarchizes or groups the information registered in the registered information storage unit 124, based on user input.

When the user inputs a message, that is, when the reception unit 11 receives a message input by the user, the display control unit 15 causes the one or more pieces of information, which are registered as registered information in the registered information storage unit 124, to be displayed as selectable items. For example, the display control unit 15 causes a response or responses included in the one or more pieces of information, which are registered as registered information in the registered information storage unit 124, to be displayed as selectable items. The display control unit 15 further causes a history to be displayed when the reception unit 11 receives the message input by the user. The history is a history of messages from the user and responses from the AI 150 having been received until the AI 150 generates a response for which the predetermined instruction is input.

The registered information utilization unit 17 functions as an example of a generation unit that generates a prompt in a case where any piece of registered information is selected from the one or more pieces of registered information displayed as selectable items by the display control unit 15 when the reception unit 11 receives the message input by the user. The prompt includes the message and the selected piece of registered information. Generating a prompt using the selected pieces of registered information refers to generating a prompt including the message and the selected information. In this case, the AI control unit 14 transmits the prompt to the AI 150. In response, the AI 150 generates a response based on the prompt. Thus, the user can cause the AI 150 to generate a new response based on the registered information.

The processes performed by the information processing system 1 will be described below.

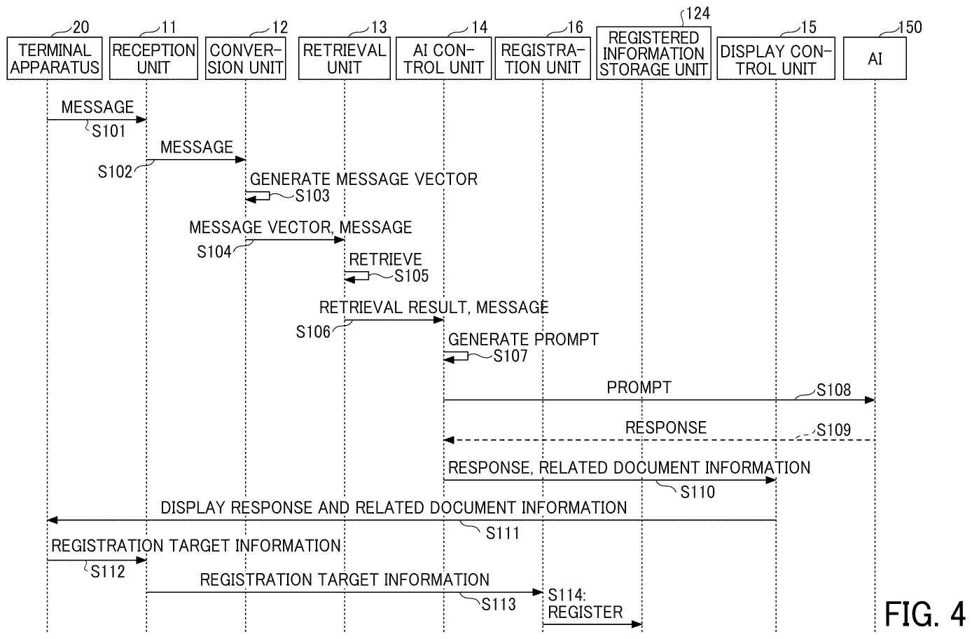

FIG. 4 is a sequence diagram of a process executed by the information processing system 1 in a response registration phase.

When the user inputs a message into the terminal apparatus 20, in step S101, the terminal apparatus 20 transmits the message to the information processing apparatus 10. The message is input through the interactive screen displayed on the terminal apparatus 20 by the display control unit 15.

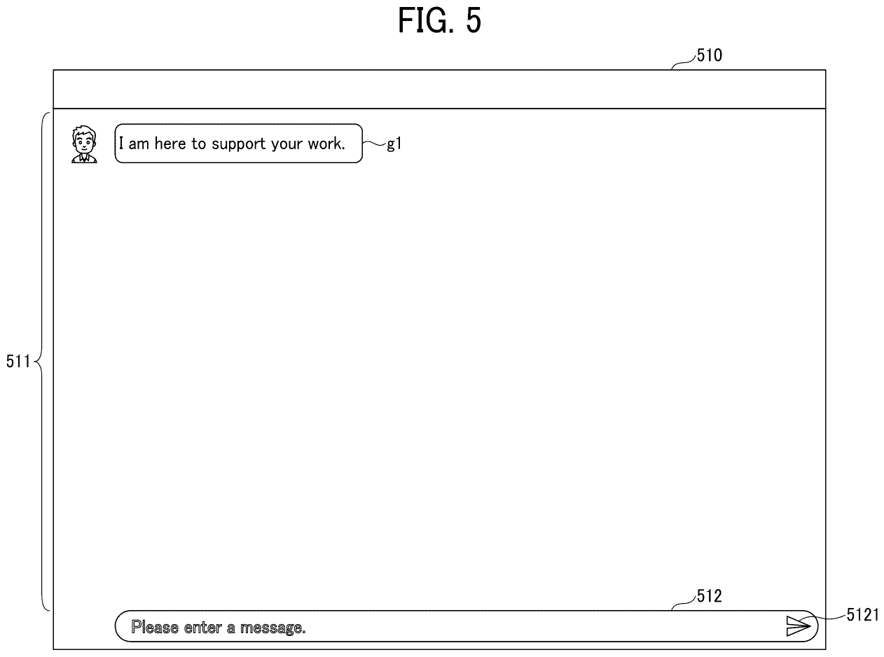

FIG. 5 is a diagram illustrating an interactive screen. An interactive screen 510 illustrated in FIG. 5 includes an interactive display area 511 and a message input area 512. The interactive display area 511 is an area in which the content of the interaction between the agent a1 and the user is displayed. In the initial state, the interactive display area 511 displays a greeting sentence g1 “I am here to support your work.” to prompt the user to input a message. The message input area 512 is an area for receiving input of a message from the user, and includes a send icon 5121.

When the user inputs a message into the message input area 512 and clicks the send icon 5121, in step S101 of FIG. 4, the terminal apparatus 20 transmits the message, which may be referred to as a “subject message” in the following description, to the information processing apparatus 10.

When the reception unit 11 of the information processing apparatus 10 receives the subject message, in step S102, the reception unit 11 inputs the subject message into the conversion unit 12.

In step S103, the conversion unit 12 converts the input subject message into a semantic vector to generate a message vector. In step S104, the conversion unit 12 inputs the message vector, which may be referred to as a “subject message vector” in the following description, and the subject message into the retrieval unit 13.

In step S105, the retrieval unit 13 compares the input subject message vector with the chunk vector stored in the data storage unit 121 for each unit of document data and for each chunk, to specify the similar chunks for each unit of document data and extract one or more similar chunks having a relatively high similarity to the subject message. The retrieval unit 13 generates, for each extracted similar chunk, a retrieval result including the related document information of the similar chunk. The related document information of a certain similar chunk includes the chunk ID of the similar chunk, the document ID of the document data to which the similar chunk belongs, and the document name of the document data. In step S106, the retrieval unit 13 inputs the retrieval result and the subject message into the AI control unit 14.

In step S107, the AI control unit 14 generates a prompt by inserting the input retrieval result and subject message to the system prompt. In step S108, the AI control unit 14 transmits the prompt to the AI 150. In step S109, the AI control unit 14 receives, from the AI 150, a response generated by the AI 150 to which the prompt is input. The AI control unit 14 records the response in the history information storage unit 123 in association with the subject message and the retrieval result.

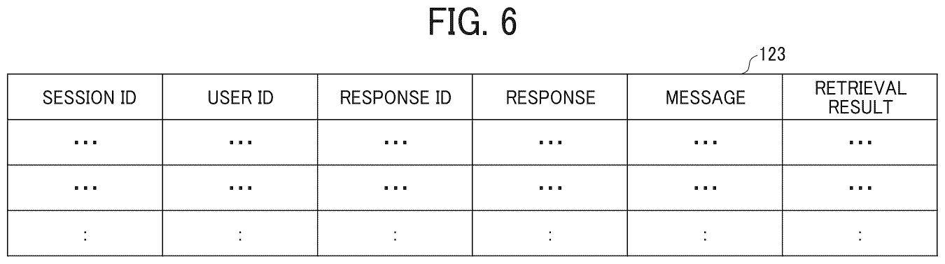

FIG. 6 is a diagram illustrating a configuration of the history information storage unit 123. As illustrated in FIG. 6, the history information storage unit 123 stores, for each response from the AI 150, history information including a session ID, a user ID, a response ID, a message, and a retrieval result. The session ID is an ID unique to each session. The session refers to a series of exchanges of messages and responses between the user and the agent a1, which are performed from when the interactive screen 510 is displayed to when the interactive screen 510 is closed. The same session ID is assigned to responses output in the same session. The user ID is identification information of a user who has performed a session (interaction) relevant to the session ID. For example, the user ID may be specified by user authentication before the interactive screen 510 is displayed. The response ID is, for example, an ID unique to each response, and is given when the AI control unit 14 records the response in the history information storage unit 123, for example. The message and the retrieval result are those inserted to the prompt that is the source of the response.

Referring back to FIG. 4, in step S110, the AI control unit 14 inputs response information including the response, which may be referred to as a “subject response” in the following description, and the related document information of the retrieval result into the display control unit 15.

In step S111, the display control unit 15 causes the input response information, including the subject response and the related document information, to be displayed on the interactive screen 510, which is displayed on the terminal apparatus 20.

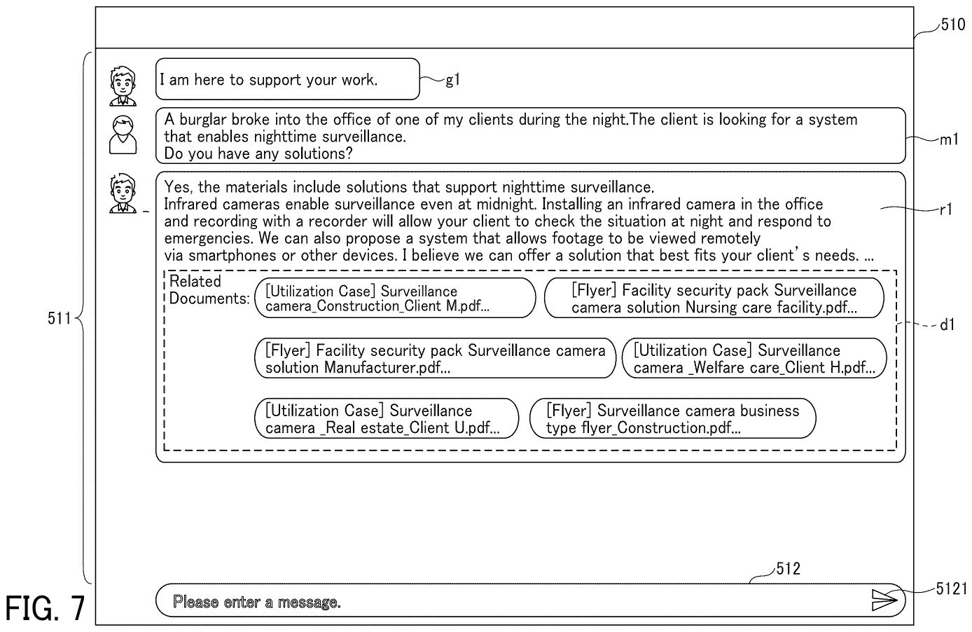

FIG. 7 is a diagram illustrating response information as displayed. In FIG. 7, identical or similar reference signs denote identical or similar elements illustrated in FIG. 5, and redundant descriptions thereof are omitted unless otherwise required. In the interactive screen 510 illustrated in FIG. 7, a message m1, a response r1, and related document information d1 are added.

The message m1 is the subject message that the user has input in the message input area 512 in step S101. When the user clicks the send icon 5121, the subject message input in the message input area 512 is displayed in the interactive display area 511.

The response r1 is the subject response. The related document information d1 is the related document information for the subject response. Accordingly, information including the response r1 and the related document information d1 is the response information to the message m1. In FIG. 7, a list of document names included in the related document information is displayed as the related document information d1.

The user may continue the interaction as it is, or may give a predetermined instruction, which may be referred to as “registration instruction” in the following description, when the user wants to register the response information in the registered information storage unit 124 for later use.

In the registration instruction, information relevant to a part of the response information (the response r1 or the related document information d1) can be selected. For example, when the response r1 is to be registered, the user performs a predetermined operation on the display area of the response r1 to select the response r1 as a registration target. The predetermined operation is, for example, selecting a menu item corresponding to “register” among menu items displayed by right-clicking a mouse. When any one of the units of document data in the related document information d1 is to be registered, the user performs the predetermined operation on the document name of the document data to be registered, to select the document data as a registration target. In the present embodiment, it is assumed that a single registration target can be selected in one registration. Alternatively, the predetermined operation may be performed while multiple registration targets are selected. When the user performs the predetermined operation, the terminal apparatus 20 displays a confirmation screen.

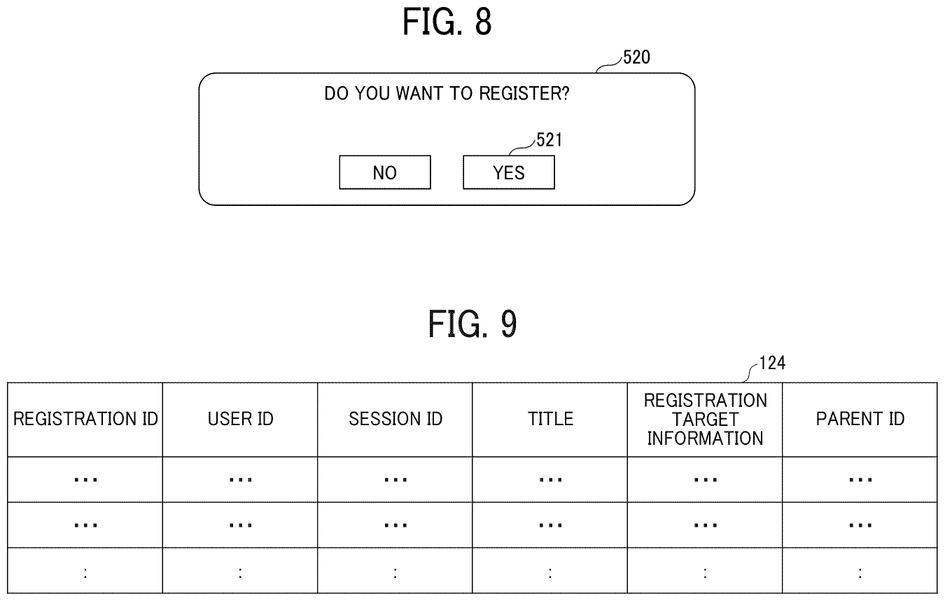

FIG. 8 is a diagram illustrating a confirmation screen as displayed. As illustrated in FIG. 8, a confirmation screen 520 is a screen for confirming with the user whether to execute registration of the registration target. When the user presses a button 521 corresponding to the execution of registration, step S112 and subsequent steps in FIG. 4 are executed.

In step S112, the terminal apparatus 20 transmits identification information of the registration target, which may be referred to as “registration target information” in the following description, to the information processing apparatus 10. When the response r1 is selected as the registration target, the response ID of the response r1 is the registration target information. When any one of the units of document data is selected as a registration target, the document ID of the document data and the chunk ID of the similar chunk used for generating the response r1 in the document data are the registration target information.

When the reception unit 11 of the information processing apparatus 10 receives the registration target information, in step S113, the reception unit 11 inputs the registration target information into the registration unit 16. In step S114, the registration unit 16 registers the registration target information in the registered information storage unit 124.

FIG. 9 is a diagram illustrating a configuration of the registered information storage unit 124. As illustrated in FIG. 9, the registered information storage unit 124 stores, for each registration target, registered information including a registration ID, a user ID, a session ID, a title, registration target information, and a parent ID. In other words, the record of one row in FIG. 9 is the registered information. The registration ID is an ID uniquely assigned by, for example, the registration unit 16 when the registration target information is registered in the registered information storage unit 124. The user ID is a user ID of a user who has registered the registered information. The session ID is a session ID of a session (interaction) to which a response corresponding to the registered information belongs, that is, a session (interaction) in which the response is performed. The session ID included in the registered information has a meaning as association information with the history information in the history information storage unit 123 illustrated in FIG. 6. In other words, the registration unit 16 registers the registered information in association with a session (interaction) including a response relevant to the registered information. The title is a character string that concisely expresses the registration target relevant to the registration target information. For example, when the registration target is document data, the document name of the document data may be the title. When the registration target is a response, text that is obtained by summarizing the response may be used as the title. The summary may be generated by the registration unit 16 using a typical technique. The parent ID is an item for enabling management of the registered information in a grouped and hierarchical manner. For example, by generating registered information corresponding to folders and setting the parent-child relationship between the folders, the registered information can be managed in a grouped and hierarchical manner.

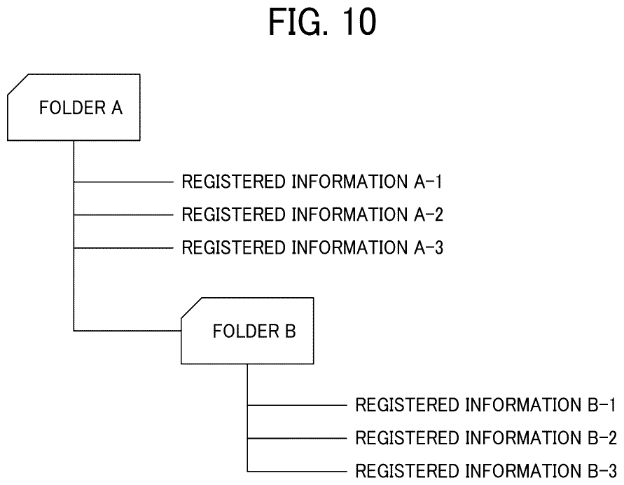

FIG. 10 is a diagram illustrating grouping and hierarchization of registered information. In FIG. 10, three pieces of registered information A-1 to A-3 and a folder B belong to a folder A, and three pieces of registered information B-1 to B-3 belong to the folder B.

The folders A and B are virtual containers for grouping the pieces of registered information. In the present embodiment, each of the folders A and B is also registered as one piece of registered information in the registered information storage unit 124. In this case, the registered information corresponding to each of the folders A and B is a record including the registration ID and having the folder name as a title.

In FIG. 10, the registration ID of the registered information of the folder A is recorded as the “parent ID” of each of the three pieces of registered information A-1 to A-3 and the registered information of the folder B. The registration ID of the registered information of the folder B is recorded as the “parent ID” of each of the three pieces of registered information B-1 to B-3. In this way, the grouping and hierarchization illustrated in FIG. 10 are represented. The operation way for the grouping and hierarchization is deferred.

Execution of step S112 and the subsequent steps illustrated in FIG. 4 multiple times for one output of a response allows respective pieces of information associated with multiple registration targets to be registered as registered information in the registered information storage unit 124.

A description is given below of a registered information utilization phase, in which the AI 150 generates a response to a prompt using registered information.

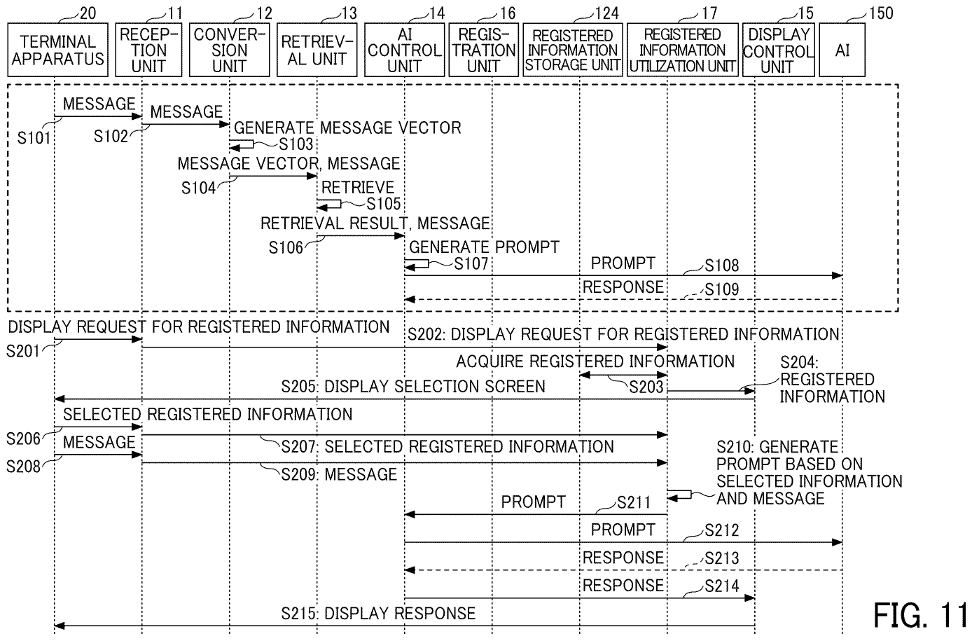

FIG. 11 is a sequence diagram of a process executed by the information processing system 1 in the registered information utilization phase. In FIG. 11, identical or similar step numbers denote identical or similar steps illustrated in FIG. 4, and redundant descriptions thereof are omitted unless otherwise required.

In FIG. 11, it is assumed that one or more pieces of information are registered as registered information in the registered information storage unit 124. In this case, when the display control unit 15 causes the subject response and the related document information to be displayed on the interactive screen 510 in step S111, the display control unit 15 causes a button for receiving a user instruction to be displayed on the interactive screen 510. The user instruction is an instruction to use the registered information.

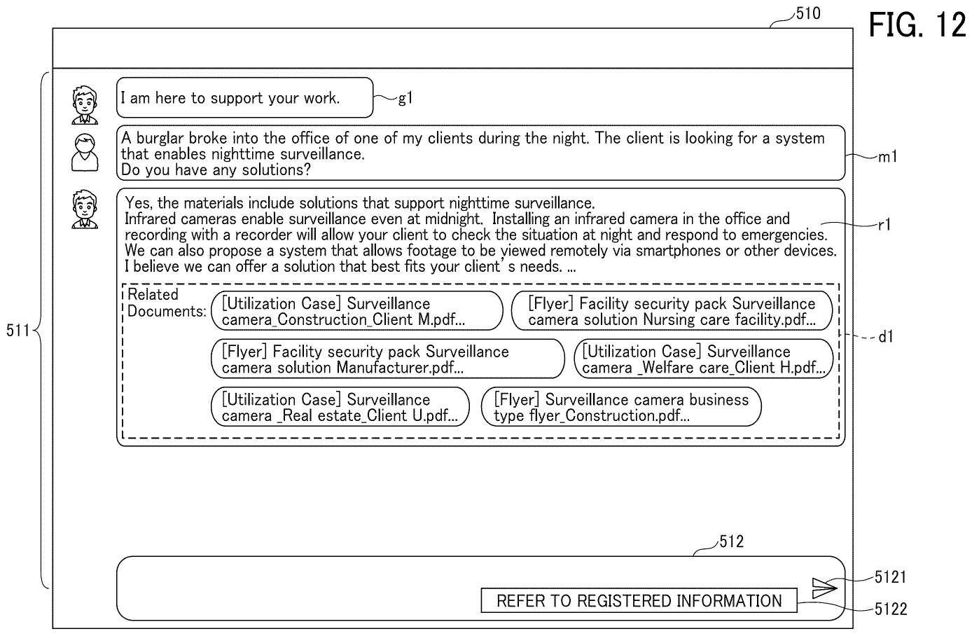

FIG. 12 is a diagram illustrating an interactive screen as displayed when one or more pieces of information are registered as registered information. In FIG. 12, identical or similar reference signs denote identical or similar elements illustrated in FIG. 7, and redundant descriptions thereof are omitted unless otherwise required.

In the interactive screen 510 illustrated in FIG. 12, a button 5122 is added in the message input area 512. The button 5122 is a button for receiving, from the user, an instruction to use (refer to) the registered information for a message to be input. When the user clicks the button 5122, step S201 and the subsequent steps are executed.

In step S201, the terminal apparatus 20 transmits a display request for the registered information to the information processing apparatus 10.

In response to the display request, in step S202, the reception unit 11 of the information processing apparatus 10 inputs the display request into the registered information utilization unit 17. In response to the display request, in step S203, the registered information utilization unit 17 acquires (reads) a list of registered information (for example, all pieces of registered information) stored in the registered information storage unit 124. In step S204, the registered information utilization unit 17 inputs the acquired (read) list of registered information into the display control unit 15. In step S205, the display control unit 15 causes a selection screen to be displayed on the terminal apparatus 20 to allow the user to select the registered information to be used for a message from the list of registered information.

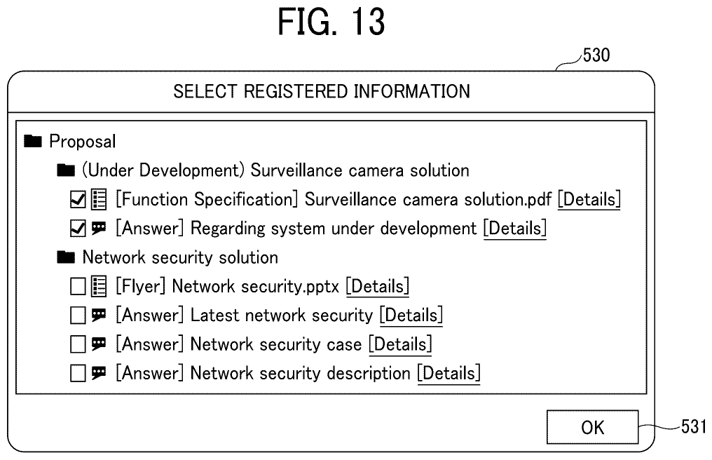

FIG. 13 is a diagram illustrating a selection screen as displayed. As illustrated in FIG. 13, a selection screen 530 includes the titles of respective pieces of registered information in a selectable state. FIG. 13 illustrates an example in which the titles of respective pieces of registered information are displayed based on the hierarchical relationship (parent-child relationship) of the pieces of registered information described above with reference to FIG. 10. In FIG. 13, a character string “[Details]” follows the title of each piece of registered information, and a link to the details of the registered information is provided for the character string. The presence of the link is indicated by an underline. When a link corresponding to any piece of registered information is clicked, the terminal apparatus 20 transmits the registration ID of the registered information to the information processing apparatus 10. Based on the registration target information included in the registered information relevant to the transmitted registration ID, the display control unit 15 of the information processing apparatus 10 causes a registration target corresponding to the registration target information to be displayed on the terminal apparatus 20. The registration target is a response relevant to the registered information or a similar chunk used for generating the response. Alternatively, the display control unit 15 may cause history information corresponding to the session ID included in the registered information to be displayed on the terminal apparatus 20. The history information indicates a history of interactions between the user and the AI 150, including messages from the user and responses from the AI 150. The history of interactions is generated by acquiring history information including the session ID from the history information storage unit 123 illustrated in FIG. 6. Displaying such information allows the user to confirm, for example, “in what kind of interaction the response is.”

The selection screen 530 may enable an editing operation for grouping and hierarchizing the pieces of registered information. For example, the user may drag and drop a node, which is a folder or registered information, in the tree structure to change the parent of the node. In this case, the terminal apparatus 20 transmits to the information processing apparatus 10 the folder or the registered information as an operation target and the ID of the drop destination to which the operation target is dropped. The registration unit 16 of the information processing apparatus 10 updates the parent ID of the registered information to the ID of the drop destination in the registered information storage unit 124. In this way, the grouping or hierarchical structure of the pieces of registered information can be changed. The user may perform a predetermined operation to generate a new folder. The folder may be generated under another folder or may be generated as a root folder that does not belong to any folder. When the user performs an operation for generating a folder, the terminal apparatus 20 transmits to the information processing apparatus 10 folder information including a folder name input in the operation. When the folder is generated under any folder, the ID of the parent folder (parent ID) is also included in the folder information. The registration unit 16 of the information processing apparatus 10 adds information including the folder information to the registered information storage unit 124 as registered information.

When the user selects one or more pieces of registered information from the pieces of registered information included in the selection screen 530 illustrated in FIG. 13 and clicks a button 531, in step S206 of FIG. 11, the terminal apparatus 20 transmits the one or more selected pieces of registered information to the information processing apparatus 10. Each selected piece of registered information may be referred to simply as “selected registered information” in the following description. For the registered information of document data as a registration target, the user may be allowed to select whether to set a use range to the entire document data or to set a use range to a similar chunk relevant to a chunk ID included in registration target information of the registered information. When the entire document data is selected, document data utilization information indicating that the entire document data is used may be added to the selected registered information.

When the reception unit 11 of the information processing apparatus 10 receives one or more selected pieces of registered information, in step S207, the reception unit 11 inputs the one or more selected pieces of registered information into the registered information utilization unit 17. The registered information utilization unit 17 stores the one or more selected pieces of registered information that have been input.

Subsequently, the user inputs a message into the message input area 512 of the interactive screen 510 illustrated in FIG. 12.

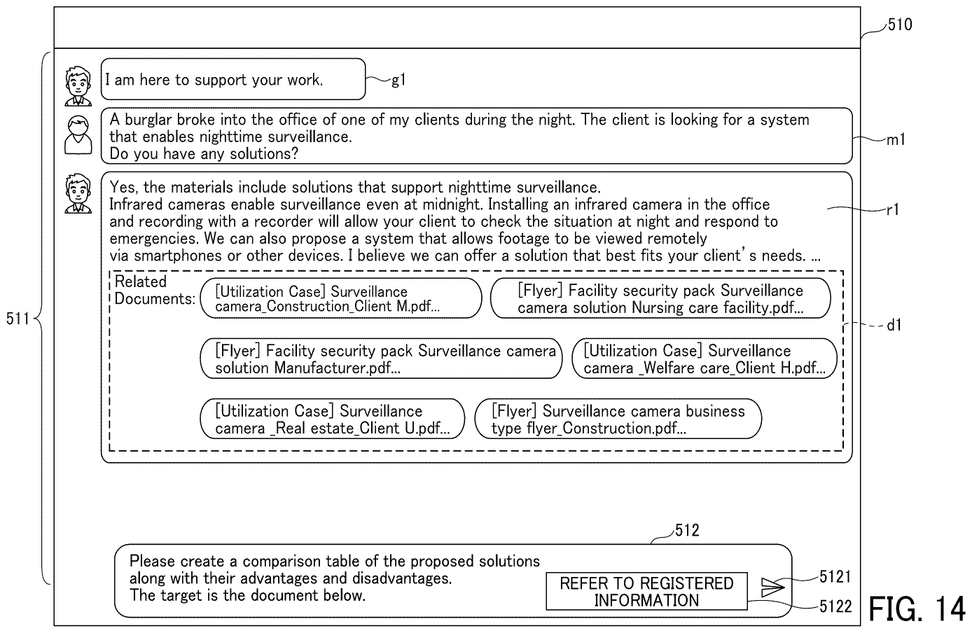

FIG. 14 is a diagram illustrating an interactive screen to which a message is input after one or more pieces of registered information are selected.

FIG. 14 illustrates an example in which a message “Please create a comparison table of the proposed solutions along with their advantages and disadvantages. The target is the document below.” is input. In the message, the “proposed solutions” refer to solutions included in the response r1 displayed in the interactive display area 511.

The “document below” is a document to be compared with the “proposed solutions,” and is a registration target of the selected registered information, such as a response, document data, or a similar chunk. The message input area 512 may include an icon that identifiably indicates the one or more selected pieces of registered information.

When the user inputs a message and clicks the send icon 5121, in step S208 of FIG. 11, the terminal apparatus 20 transmits the message, which may be referred to as “subject message” in the following description, to the information processing apparatus 10.

In response to the subject message, in step S209, the reception unit 11 of the information processing apparatus 10 inputs the subject message into the registered information utilization unit 17.

In step S210, the registered information utilization unit 17 generates a prompt based on the selected registered information stored in step S207 and the subject message. For example, the registered information utilization unit 17 acquires, for each selected piece of registered information, a registration target relevant to registration target information of the selected registered information. When the registration target information includes a response ID, the registered information utilization unit 17 acquires a response corresponding to the response ID from the history information storage unit 123 illustrated in FIG. 6. When the registration target information includes a document ID and a chunk ID, the registered information utilization unit 17 acquires, from the data storage unit 121, a similar chunk corresponding to the chunk ID among the entire text of the document data relevant to the document ID. However, when the document data utilization information is added to the selected registered information, the registered information utilization unit 17 acquires the entire text of the document data relevant to the document ID. The registered information utilization unit 17 generates the prompt by inserting the acquired registration target and subject message to, for example, a system prompt previously stored in the template storage unit 122. Since the prompt including the registration target is generated, the system prompt is different from the system prompt used in step S107. The following is a simple example of the system prompt generated in step S210.
<Example of system prompt begins.>
The message from the user is as follows.
{Message}
{Set of registration targets relevant to selected registered information}
<Example of system prompt ends.>

In this case, the registered information utilization unit 17 generates a prompt by inserting the subject message to the {message} section of the system prompt and inserting the registration target acquired for each selected piece of registered information, such as a response, document data, or a similar chunk, to the {set of registration targets relevant to selected registered information} section.

In step S211, the registered information utilization unit 17 inputs the generated prompt into the AI control unit 14. In step S212, the AI control unit 14 transmits the prompt to the AI 150. In step S213, the AI control unit 14 receives, from the AI 150, a response generated by the AI 150 to which the prompt is input. The AI control unit 14 records the response in the history information storage unit 123 illustrated in FIG. 6 in association with the subject message and the retrieval result. Since the retrieval result by the retrieval unit 13 is not used, the retrieval result may not be recorded.

In step S214, the AI control unit 14 inputs the response, which may be referred to as a “subject response” in the following description, into the display control unit 15.

In step S215, the display control unit 15 causes the input subject response to be displayed on the interactive screen 510, which is displayed on the terminal apparatus 20. Thus, the user can refer to the response based on the responses and related document information in the past interactions, for the newly input message.

As described above, a response corresponding to a message input by a user and document information used for generating the response can be registered as registered information like a bookmark. The user can use the response or the document information relevant to the registered information by selecting any piece of registered information in a message to be input thereafter. Thus, the response generated by the AI 150 is selectable when the user inputs the message.

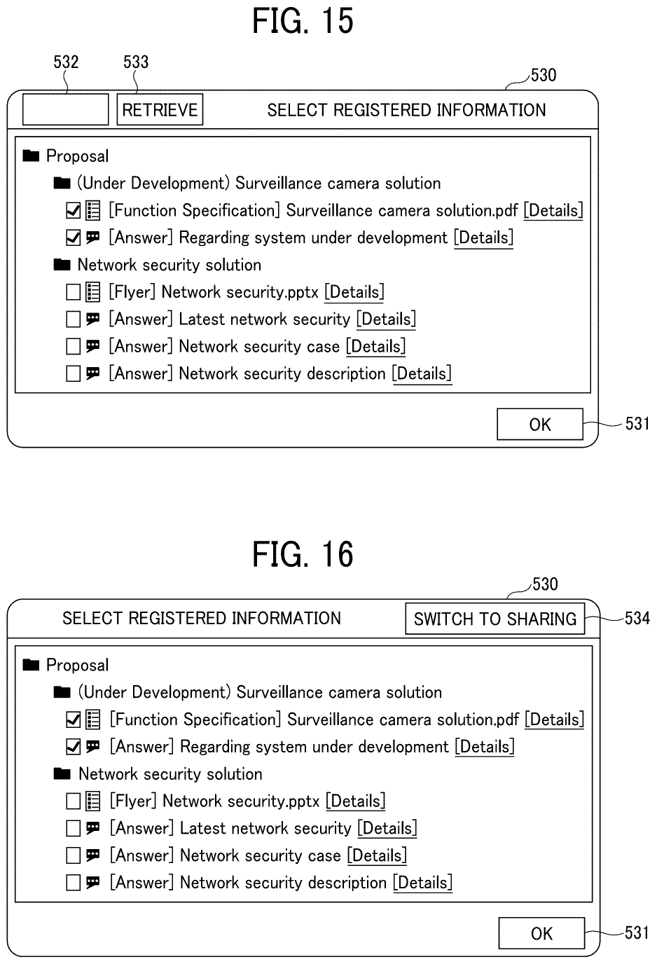

In step S205 of FIG. 11, the display control unit 15 may cause a selection screen as illustrated in FIG. 15 to be displayed on the terminal apparatuses 20 to increase the efficiency for the user to retrieve desired registered information.

FIG. 15 is a diagram illustrating a second example of the selection screen. In FIG. 15, identical or similar reference signs denote identical or similar elements illustrated in FIG. 13, and redundant descriptions thereof are omitted unless otherwise required. The selection screen 530 illustrated in FIG. 15 further includes a text box 532 and a button 533.

The text box 532 is an area for receiving input of a retrieval condition, such as a keyword, for the registered information. The button 533 is a button for receiving an instruction to retrieve registered information matching the keyword input in the text box 532.

When a keyword is input in the text box 532 and the button 533 is pressed, the terminal apparatus 20 extracts registered information matching the keyword from one or more pieces of registered information displayed, and displays the extracted registered information on the selection screen 530. The registered information matching the keyword is, for example, registered information including the keyword in the title or registered information of a registration target including the keyword.

The registered information storage unit 124 illustrated in FIG. 9 may be divided into a private area and a public area. The private area is an individual area for each user. Only the user relevant to the user ID included in the registered information can refer to the information registered in the private area. The public area is an area in which multiple users can share registered information. Users other than the user relevant to the user ID included in the registered information can refer to the information registered in the public area. When access to each record in the history information storage unit 123 illustrated in FIG. 6 is limited to the user relevant to the user ID of the record, no other users can use a response as a registration target having the information registered in the public area even though the registered information is open to the other users. To address such a situation, a record corresponding to a registration target of the information registered in the public area may be treated as being open to other users in the history information storage unit 123 illustrated in FIG. 6. In this case, in step S205 of FIG. 11, the display control unit 15 may cause a selection screen as illustrated in FIG. 16 to be displayed.

FIG. 16 is a diagram illustrating a third example of the selection screen. In FIG. 16, identical or similar reference signs denote identical or similar elements illustrated in FIG. 13, and redundant descriptions thereof are omitted unless otherwise required. The selection screen 530 illustrated in FIG. 16 further includes a button 534.

The button 534 is a button for receiving an instruction to display information registered in the public area, that is, shared registered information. In other words, the display control unit 15 causes the information registered in the private area to be displayed on the selection screen 530 as a basic operation. When the button 534 is clicked by the user, the terminal apparatus 20 transmits a display request for the information registered in the public area to the information processing apparatus 10. When the reception unit 11 of the information processing apparatus 10 receives the display request, operations similar to those in steps S201 to S205 of FIG. 11 are executed. However, the display request for registered information transmitted in steps S201 and S202 refers to a display request for the information registered in the public area. Accordingly, in step S203, the registered information utilization unit 17 acquires only the information registered in the public area. Alternatively, the registered information utilization unit 17 may acquire the information registered in the public area in addition to the information registered in the private area of the user who is currently logged in. As a result, in step S205, the selection screen 530 including the information registered in the public area is displayed.

The agent a1 may recommend the registered information to be used. For example, the selection screen 530 may display registered information having a relatively high relevance to past interactions or a newly input message among the pieces of registered information stored in the registered information storage unit 124. The registered information having a relatively high relevance to interactions or a message is, for example, registered information having a relatively high semantic similarity to past interactions or a newly input message for the registration target indicated by the title or the registration target information among the components of the registered information illustrated in FIG. 9.

Data analysis and generation of a graph indicating the relevance of each registration target may be performed using the registration target of the registered information, such as a response or document data (chunk). The graph indicating the relevance is, for example, a graph in which registration targets having a similarity equal to or greater than a threshold are connected, as nodes, by an edge.

The registered information storage unit 124 may be located outside the information processing apparatus 10. For example, the registered information storage unit 124 may be implemented by cloud storage or another external storage.

A second embodiment is described below. In the second embodiment, the differences from the first embodiment (or aspects not clearly described) are described. Accordingly, aspects not specifically mentioned may be similar to those in the first embodiment.

In the second embodiment, the terminal apparatus 20 displays various screens by a web browser, and the information processing apparatus 10 has a function as a web server that executes a web application.

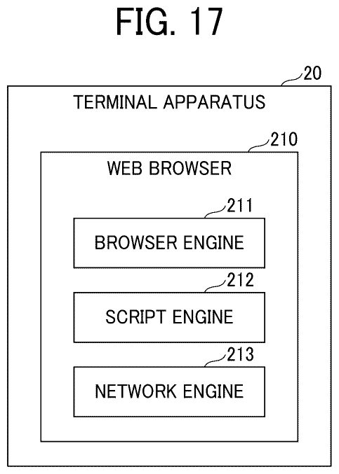

FIG. 17 is a diagram illustrating a functional configuration of the terminal apparatus 20 according to the second embodiment. In FIG. 17, the terminal apparatus 20 includes a web browser 210. The web browser 210 is a typical web browser, and includes a browser engine 211, a script engine 212, and a network engine 213.

The browser engine 211 interprets HyperText Markup Language (HTML) data and Cascading Style Sheets (CSS) data constituting a web page and renders the web page for display.

The script engine 212 executes a script (for example, JavaScript™) constituting a web page.

The network engine 213 transmits a HyperText Transfer Protocol (HTTP) request and receives an HTTP response.

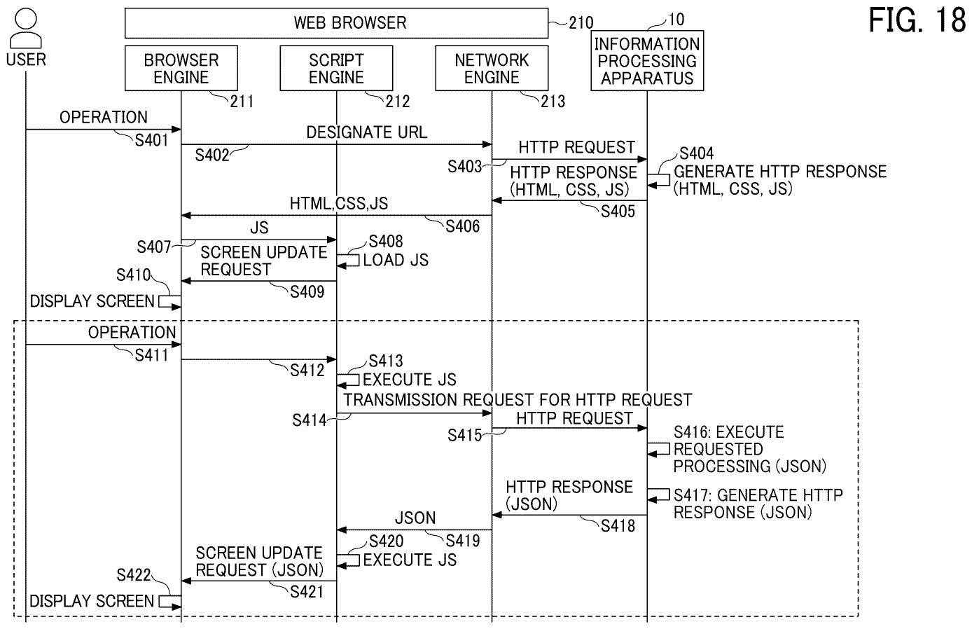

FIG. 18 is a sequence diagram of a process related to screen transition according to the second embodiment.

In step S401, the user gives an instruction on the web browser 210 to display the interactive screen 510. In response to the instruction, in step S402, the browser engine 211 inputs, into the network engine 213, a Uniform Resource Locator (URL) that is associated with the display instruction and serves as a destination for an HTTP request to the information processing apparatus 10. In step S403, the network engine 213 transmits the HTTP request to the URL. For example, the URL may be registered in a bookmark of the web browser 210, may be associated with a menu of a menu screen provided by the information processing apparatus 10, or may be directly input by the user. The information indicating the URL may be searched by the user using a search engine.

In response to the HTTP request, in step S404, the display control unit 15 of the information processing apparatus 10 generates an HTTP response including web content data corresponding to the URL to which the HTTP request is addressed. The web content data includes HTML data, CSS data, and a script, which may be referred to as “JS” in the following description. The web content is used to display multiple web pages to be displayed later. The JS includes multiple JS scripts that execute processing according to an operation on each screen.

In step S405, the display control unit 15 transmits the HTTP response generated in step S404 to the terminal apparatus 20.

In response to the HTTP response, in step S406, the network engine 213 of the terminal apparatus 20 inputs the HTML data, the CSS data, and the JS included in the HTTP response into the browser engine 211. In step S407, the browser engine 211 inputs the JS received from the network engine 213 into the script engine 212. In step S408, the script engine 212 loads the JS. In step S409, the script engine 212 requests the browser engine 211 to update the screen. Updating the screen includes displaying a new screen.

The HTTP response generated in step S404 may include the filename of the JS instead of the actual JS. In this case, in step S408, the script engine 212 accesses an external file based on the filename, and downloads the JS. This is a way of reading a JS as an external file.

In step S410, the browser engine 211 displays the interactive screen 510 based on the HTML data and the CSS data.

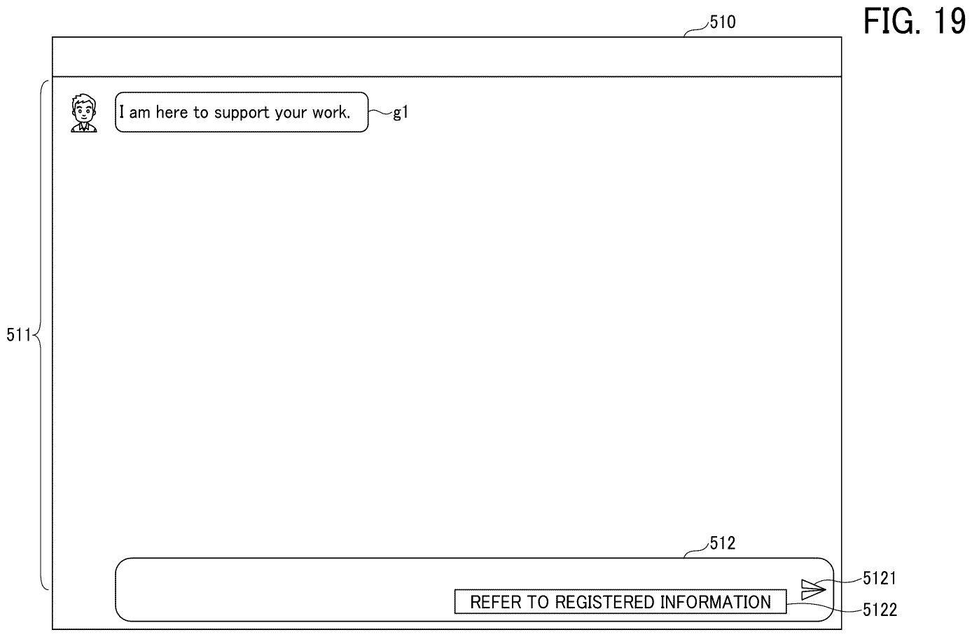

FIG. 19 is a diagram illustrating a first interactive screen as displayed, according to the second embodiment. In the second embodiment, it is assumed that one or more pieces of information have already been registered as registered information. Accordingly, the interactive screen 510 illustrated in FIG. 19 includes the button 5122 in the message input area 512 as described above with reference to FIG. 12.

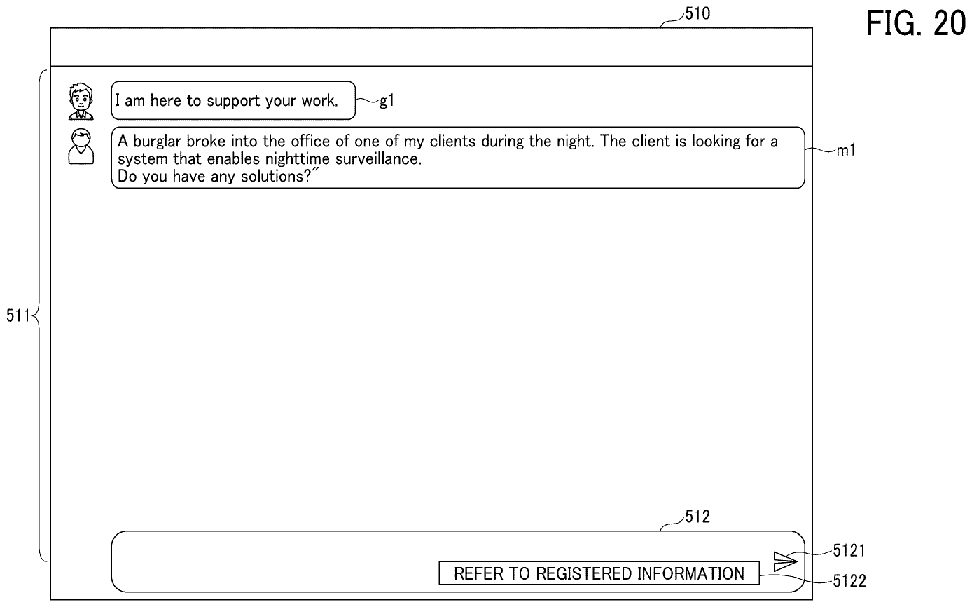

In step S411 of FIG. 18, the user inputs a message into the message input area 512 of the interactive screen 510 illustrated in FIG. 19 and clicks the send icon 5121. In response to the user operation, the display content of the interactive screen 510 changes as illustrated in FIG. 20. In FIG. 20, the message that has been input in the message input area 512 of FIG. 19 is displayed as the message m1 in the interactive display area 511.

In step S412 of FIG. 18, the browser engine 211 transmits to the script engine 212 a notification indicating that the message has been input and the message.

In response to the notification from the browser engine 211, in step S413, the script engine 212 executes a JS of multiple JS scripts, the JS being for transmitting the input message to the information processing apparatus 10. In step S414, the script engine 212 inputs a transmission request for an HTTP request in response to the input of the message, together with the message, into the network engine 213. In step S415, the network engine 213 transmits the HTTP request including the message to the information processing apparatus 10.

When the reception unit 11 of the information processing apparatus 10 receives the HTTP request, in step S416, the information processing apparatus 10 executes processing requested by the HTTP request. Steps S102 to S110 illustrated in FIG. 4 are executed for the HTTP request in response to the input of the message on the interactive screen 510 illustrated in FIG. 20. Accordingly, a response to the input message and related document information are obtained as a processing result.

In step S417, the display control unit 15 generates an HTTP response including JavaScript Object Notation (JSON) in which the response and the related document information as the processing result is described. In step S418, the display control unit 15 transmits the HTTP response to the terminal apparatus 20.

In response to the HTTP response, in step S419, the network engine 213 of the terminal apparatus 20 inputs the JSON included in the HTTP response into the script engine 212. In step S420, the script engine 212 executes a JS of multiple JS scripts, the JS being for updating the display content of the web page based on the JSON. In step S421, the script engine 212 requests the browser engine 211 to update the display content of the web page based on the JSON. In step S422, the browser engine 211 updates the display content of the interactive screen 510 from the state illustrated in FIG. 20 to the state illustrated in FIG. 12, based on the HTML data and the CSS data acquired in step S406 and the JSON.

Thereafter, steps S411 to S422 are repeated in response to a user operation on the interactive screen 510. However, the data to be processed in each step changes.

For example, in step S411, the user clicks the button 5122 on the interactive screen 510 illustrated in FIG. 12. In response to the user operation, in step S412, the browser engine 211 transmits to the script engine 212 a notification indicating that the button 5122 has been clicked.

In response to the notification from the browser engine 211, in step S413, the script engine 212 executes a JS of multiple JS scripts, the JS being for transmitting information corresponding to the clicked button 5122 to the information processing apparatus 10. In step S414, the script engine 212 inputs a transmission request for an HTTP request in response to the click on the button 5122 into the network engine 213. In step S415, the network engine 213 transmits the HTTP request in response to the click on the button 5122 to the information processing apparatus 10. The HTTP request in response to the click on the button 5122 corresponds to the display request for the registered information described above with reference to step S201 of FIG. 11.

When the reception unit 11 of the information processing apparatus 10 receives the HTTP request, in step S416, the information processing apparatus 10 executes processing requested by the HTTP request. Specifically, steps S202 to S204 illustrated in FIG. 11 are executed, in which the registered information utilization unit 17 reads a list of registered information (for example, all pieces of registered information) stored in the registered information storage unit 124 and acquires the list as a processing result.

In step S417, the display control unit 15 generates an HTTP response including JSON in which the list of registered information as the processing result is described. In step S418, the display control unit 15 transmits the HTTP response to the terminal apparatus 20. The HTTP response corresponds to step S205 illustrated in FIG. 11.

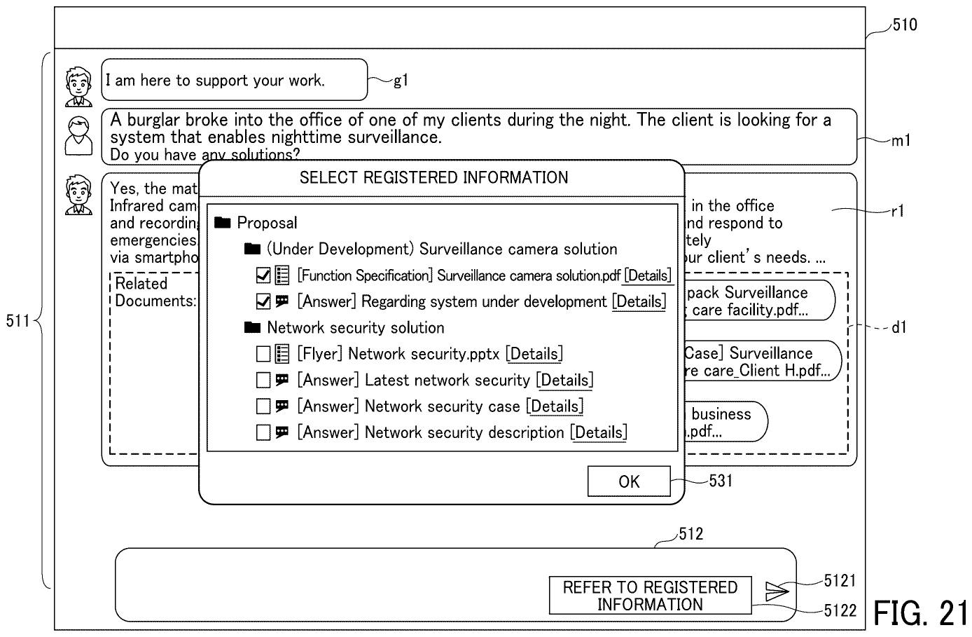

In response to the HTTP response, in step S419, the network engine 213 of the terminal apparatus 20 inputs the JSON included in the HTTP response into the script engine 212. In step S420, the script engine 212 executes a JS of multiple JS scripts, the JS being for displaying the list of registered information described in the JSON. In step S421, the script engine 212 requests the browser engine 211 to update the display content of the web page based on the JSON. In step S422, the browser engine 211 updates the display content of the interactive screen 510 from the state illustrated in FIG. 12 to the state illustrated in FIG. 21, based on the HTML data and the CSS data acquired in step S406 and the JSON.

FIG. 21 is a diagram illustrating an updated interactive screen according to the second embodiment. FIG. 21 illustrates an example in which the selection screen 530 illustrated in FIG. 13 is displayed over the interactive screen 510 illustrated in FIG. 12.

Thereafter, steps S411 to S422 are repeated in response to a user operation on the selection screen 530 illustrated in FIG. 21. However, the data to be processed in each step changes.

For example, in step S411, the user selects one or more pieces of registered information from the pieces of registered information included in the selection screen 530 illustrated in FIG. 21, and clicks the button 531. In response to the user operation, in step S412, the browser engine 211 transmits to the script engine 212 a notification indicating that the button 531 has been clicked and the one or more selected pieces of registered information (selected registered information).

In response to the notification from the browser engine 211, in step S413, the script engine 212 executes a JS of multiple JS scripts, the JS being for transmitting information corresponding to the clicked button 531 to the information processing apparatus 10. In step S414, the script engine 212 hides the selection screen 530 illustrated in FIG. 13 and inputs a transmission request for an HTTP request in response to the click on the button 531, together with the selected registered information, into the network engine 213. In step S415, the network engine 213 transmits the HTTP request including the selected registered information to the information processing apparatus 10. The transmission of the HTTP request corresponds to step S206 illustrated in FIG. 11.

When the reception unit 11 of the information processing apparatus 10 receives the HTTP request, in step S416, the information processing apparatus 10 executes processing requested by the HTTP request. Specifically, step S207 illustrated in FIG. 11 is executed and the registered information utilization unit 17 stores each selected piece of registered information included in the HTTP request.

In step S417, the display control unit 15 generates an HTTP response including JSON in which information indicating the completion of storing the selected registered information is described. In step S418, the display control unit 15 transmits the HTTP response to the terminal apparatus 20.

In response to the HTTP response, in step S419, the network engine 213 of the terminal apparatus 20 inputs the JSON included in the HTTP response into the script engine 212. In step S420, the script engine 212 executes a JS of multiple JS scripts, the JS being for updating the display content of the web page based on the JSON. In step S421, the script engine 212 requests the browser engine 211 to update the display content of the web page based on the JSON. In step S422, the browser engine 211 updates the display content of the interactive screen 510 based on the HTML data and the CSS data acquired in step S406 and the JSON. However, the update of the display content based on the JSON in which the information indicating the completion of storing the selected registered information is described is not defined in the JS. For this reason, the display content of the interactive screen 510 at this point is in the state illustrated in FIG. 12 in which the selection screen 530 of FIG. 21 is hidden.

Thereafter, steps S411 to S422 are repeated in response to a user operation on the interactive screen 510. However, the data to be processed in each step changes.

For example, in step S411, the user inputs a message into the message input area 512 of the interactive screen 510 illustrated in FIG. 12 and clicks the send icon 5121. In response to the user operation, the display content of the interactive screen 510 changes as illustrated in FIG. 14. At this time, the interactive screen 510 may display a state indicating that one or more pieces of registered information have been selected. For example, an icon for identifying the selected registered information may be displayed instead of the button 5122. In step S412, the browser engine 211 transmits to the script engine 212 a notification indicating that the message has been input and the message.

In response to the notification from the browser engine 211, in step S413, the script engine 212 executes a JS of multiple JS scripts, the JS being for transmitting the input message to the information processing apparatus 10. In step S414, the script engine 212 inputs a transmission request for an HTTP request in response to the input of the message, together with the message, into the network engine 213. In step S415, the network engine 213 transmits the HTTP request including the message to the information processing apparatus 10. The HTTP request corresponds to step S208 illustrated in FIG. 11. The HTTP request may include information for identifying the selected registered information.

When the reception unit 11 of the information processing apparatus 10 receives the HTTP request, in step S416, the information processing apparatus 10 executes processing requested by the HTTP request. Specifically, steps S209 to S214 illustrated in FIG. 11 are executed in which the registered information utilization unit 17 generates, as a processing result, a response based on the selected registered information stored and the message included in the HTTP request.

In step S417, the display control unit 15 generates an HTTP response including JSON in which the response as the processing result is described. In step S418, the display control unit 15 transmits the HTTP response to the terminal apparatus 20.

In response to the HTTP response, in step S419, the network engine 213 of the terminal apparatus 20 inputs the JSON included in the HTTP response into the script engine 212. In step S420, the script engine 212 executes a JS of multiple JS scripts, the JS being for updating the display content of the web page based on the JSON. In step S421, the script engine 212 requests the browser engine 211 to update the display content of the web page based on the JSON. In step S422, the browser engine 211 updates the display content of the interactive screen 510 from the state illustrated in FIG. 12 to a state in which the response is displayed in the interactive display area 511, based on the HTML data and the CSS data acquired in step S406 and the JSON.

As described above, in the second embodiment, web content data is transmitted to the terminal apparatus 20 in step S405. The web content data is data for displaying a first web page including a screen (for example, the interactive screen 510) for receiving input of a message from a user, and a second web page (for example, the interactive screen 510 on which the selection screen 530 is superimposed as illustrated in FIG. 21) enabling selectable display of one or more pieces of registered information. The web content data includes a script for causing the terminal apparatus 20 to execute at least a process for transmitting an instruction to retrieve the one or more pieces of registered information to the information processing apparatus 10, the instruction being input on the first web page, and a process for displaying the second web page enabling the selectable display of the one or more pieces of registered information.

The registered information utilization unit reads the one or more pieces of registered information when the reception unit receives an HTTP request that is transmitted from the terminal apparatus 20 executing the script and that includes the instruction to retrieve the one or more pieces of registered information, the instruction being input on the first web page displayed on the terminal apparatus 20 based on the web content data.

The display control unit 15 transmits, as a response to the HTTP request, an HTTP response including the one or more pieces of registered information to the terminal apparatus 20 to cause the terminal apparatus 20 to execute the script and display the second web page (step S418 corresponding to step S205 illustrated in FIG. 11).

In this way, the web content data including the JS is transmitted to the terminal apparatus 20 at one time in step S405. The JS includes JS scripts for executing a process according to an operation on the first web page, displaying a web page (for example, the second web page) after screen transition resulted from the process, and executing a process according to another operation on each web page displayed after screen transition. Since each screen transition is executed by the JS, the terminal apparatus 20 does not need to download the web content data after the screen transition again. Accordingly, the display speed of, for example, the second screen is increased and the communication load in the screen transition is reduced.

Although the main functions of the information processing system 1 are implemented by the information processing apparatus 10 in the above embodiments, the terminal apparatus 20 may have the functions of the information processing apparatus 10.

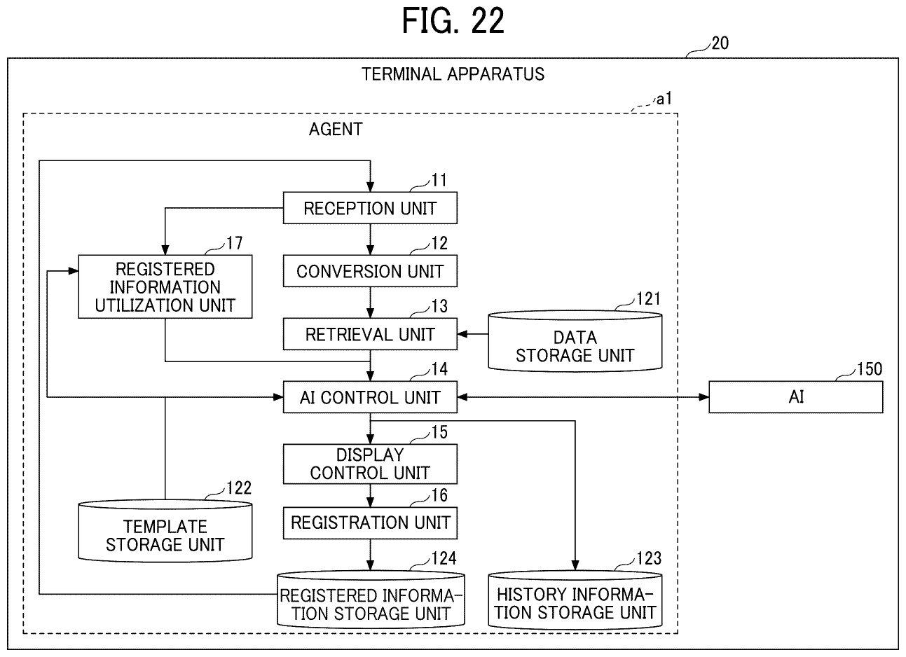

FIG. 22 is a diagram illustrating a functional configuration of the terminal apparatus 20 having the functions of the information processing apparatus 10. In FIG. 22, identical or similar reference signs denote identical or similar elements illustrated in FIG. 3, and redundant descriptions thereof are omitted unless otherwise required. As described above, the functional units illustrated in FIG. 22 have functions similar to those of the functional units illustrated in FIG. 3, and execute processes similar to the processes illustrated in the sequence diagrams of FIGS. 4 and 11. In FIG. 22, the functions of the information processing apparatus 10 in the above embodiments are implemented by processes that one or more programs installed in the terminal apparatus 20 cause the CPU of the terminal apparatus 20 to execute.

One of the information processing apparatus 10 and the terminal apparatus 20 may not have all of the functions illustrated in FIG. 3 (or FIG. 22), and each of the information processing apparatus 10 and the terminal apparatus 20 may have some of the functions. In a case where each of the information processing apparatus 10 and the terminal apparatus 20 has some functions, the classification of the function group of the information processing apparatus 10 and the function group of the terminal apparatus 20 is not limited to a specific form.

The information processing apparatus 10 may be any apparatus having a communication function, which may be implemented by communication circuitry. The information processing apparatus 10 may be, for example, an output device such as a projector (PJ), an interactive whiteboard (IWB; an electronic whiteboard having a blackboard function enabling mutual communication), or digital signage, or may be a head-up display (HUD), an industrial machine, an imaging device, a sound collecting device, a medical device, a networked home appliance, a laptop personal computer (PC), a mobile phone, a smartphone, a tablet terminal, a game console, a personal digital assistant (PDA), a digital camera, a wearable PC, or a desktop PC.

The apparatuses or devices in the above embodiments are only illustrative of one of several computing environments for implementing the one or more embodiments disclosed herein.

In some embodiments, the information processing apparatus 10 includes multiple computing devices, such as a server cluster. The multiple computing devices are configured to communicate with one another via any type of communication link, including networks or shared memory, and perform the processing disclosed herein. The terminal apparatus 20 may also include multiple computing devices configured to communicate with one another.

The following non-limiting examples illustrate aspects of the present disclosure.

According to a first aspect, an information processing system includes a reception unit, a transmission unit, a receiving unit, a display control unit, and a registration unit. The reception unit receives a message input by a user. The transmission unit transmits the received message to AI. The receiving unit receives a response generated by the AI to which the message has been transmitted. The display control unit causes information including the received response to be displayed. The registration unit registers the information in a storage unit in response to a predetermined instruction input by the user for the information. The registration unit registers one or more pieces of information, including the information including the response, to enable selectable display of the one or more pieces of information when the user inputs the message. The display control unit further causes the one or more pieces of information registered in the storage unit to be displayed as selectable items when the user inputs the message.

According to a second aspect, in the information processing system of the first aspect, the registration unit registers, in the storage unit, information relevant to a part of the information including the response, the part being selected by the user.

According to a third aspect, in the information processing system of the first or second aspect, the display control unit further causes the response included in the information registered in the storage unit to be displayed when the reception unit receives the message input by the user.

According to a fourth aspect, in the information processing system of the third aspect, the display control unit further causes a history to be displayed when the reception unit receives the message input by the user. The history is a history of messages from the user and responses from the AI having been received until the AI generates the response for which the predetermined instruction is input.

According to a fifth aspect, in the information processing system of any one of the first to fourth aspects, the registration unit hierarchizes or groups the one or more pieces of information registered in the storage unit, based on user input.

According to a sixth aspect, in the information processing system of any one of the first to fifth aspects, the display control unit generates the information including the response.

According to a seventh aspect, in the information processing system of any one of the first to sixth aspects, the information including the response includes information indicating document data.

According to an eighth aspect, the information processing system of any one of the first to seventh aspects further includes a generation unit that generates a prompt including a piece of information selected by the user from the one or more pieces of information displayed as selectable items and the message input by the user. The transmission unit transmits the prompt generated by the generation unit to the AI.

According to a ninth aspect, an information processing apparatus includes a reception unit, a transmission unit, a receiving unit, a display control unit, and a registration unit. The reception unit receives a message input by a user. The transmission unit transmits the received message to AI. The receiving unit receives a response generated by the AI to which the message has been transmitted. The display control unit causes information including the received response to be displayed. The registration unit registers the information in a storage unit in response to a predetermined instruction input by the user for the information. The registration unit registers one or more pieces of information, including the information including the response, to enable selectable display of the one or more pieces of information when the user inputs the message. The display control unit further causes the one or more pieces of information registered in the storage unit to be displayed as selectable items when the user inputs the message.

According to a tenth aspect, an information processing method executed by a computer includes a first step of receiving, a step of transmitting, a second step of receiving, a first step of display controlling, a step of registering, and a second step of display controlling. The first step of receiving includes receiving a message input by a user. The step of transmitting includes transmitting the received message to AI. The second step of receiving includes receiving a response generated by the AI to which the message has been transmitted. The first step of display controlling includes causing information including the received response to be displayed. The step of registering includes registering the information in a storage unit in response to a predetermined instruction input by the user for the information, and registering one or more pieces of information, including the information including the response, to enable selectable display of the one or more pieces of information when the user inputs the message. The second step of display controlling includes causing the one or more pieces of information registered in the storage unit to be displayed as selectable items when the user inputs the message.

According to an eleventh aspect, a program causes a computer to execute a first step of receiving, a step of transmitting, a second step of receiving, a first step of display controlling, a step of registering, and a second step of display controlling. The first step of receiving includes receiving a message input by a user. The step of transmitting includes transmitting the received message to AI. The second step of receiving includes receiving a response generated by the AI to which the message has been transmitted. The first step of display controlling includes causing information including the received response to be displayed. The step of registering includes registering the information in a storage unit in response to a predetermined instruction input by the user for the information, and registering one or more pieces of information, including the information, to enable selectable display of the one or more pieces of information when the user inputs the message. The second step of display controlling includes causing the one or more pieces of information registered in the storage unit to be displayed as selectable items when the user inputs the message.

According to a twelfth aspect, an information processing system includes a reception unit, a transmission unit, a receiving unit, a display control unit, a registration unit, and a registered information utilization unit. The reception unit receives a message input by a user. The transmission unit transmits the received message to AI. The receiving unit receives a response generated by the AI to which the message has been transmitted. The display control unit causes information including the received response to be displayed. The registration unit registers the information in a storage unit in response to a predetermined instruction input by the user for the information. The registration unit registers one or more pieces of information, including the information, to enable selectable display of the one or more pieces of information when the user inputs the message. The display control unit further causes the one or more pieces of information registered in the storage unit to be displayed as selectable items when the user inputs the message. The display control unit further transmits to a terminal apparatus web content data for displaying a first web page including a screen for receiving input of the message from the user, and a second web page enabling selectable display of the one or more pieces of registered information. The web content data includes a script for causing the terminal apparatus to execute at least a process for transmitting an instruction to retrieve the one or more pieces of registered information to an information processing apparatus, the instruction being input on the first web page, and a process for displaying the second web page enabling the selectable display of the one or more pieces of registered information. The registered information utilization unit reads the one or more pieces of registered information when the reception unit receives an HTTP request that is transmitted from the terminal apparatus executing the script and that includes the instruction to retrieve the one or more pieces of registered information, the instruction being input on the first web page displayed on the terminal apparatus based on the web content data. The display control unit transmits, as a response to the HTTP request, an HTTP response including the one or more pieces of registered information to the terminal apparatus to cause the terminal apparatus to execute the script and display the second web page.

According to a thirteenth aspect, a terminal apparatus includes a reception unit, a display control unit, and a registration unit. The reception unit receives a message input by a user. The display control unit causes information including a response from AI to the received message. The registration unit registers the information in a storage unit in response to a predetermined instruction input by the user for the information. The registration unit registers one or more pieces of information, including the information including the response, to enable selectable display of the one or more pieces of information when the user inputs the message. The display control unit further causes the one or more pieces of information registered in the storage unit to be displayed as selectable items when the user inputs the message.

According to a fourteenth aspect, an information processing system includes an information processing apparatus and a terminal apparatus. The information processing apparatus includes a reception unit, a transmission unit, a receiving unit, a display control unit, and a registration unit. The reception unit receives a message input by a user. The transmission unit transmits the received message to AI. The receiving unit receives a response generated by the AI to which the message has been transmitted. The display control unit causes information including the received response to be displayed. The registration unit registers the information in a storage unit in response to a predetermined instruction input by the user for the information. The registration unit registers one or more pieces of information, including the information including the response, to enable selectable display of the one or more pieces of information when the user inputs the message. The display control unit further causes the one or more pieces of information registered in the storage unit to be displayed as selectable items when the user inputs the message. The terminal apparatus includes a reception unit and a display control unit. The reception unit receives input of the message. The display control unit displays, on a display, the information including the response. The display control unit displays the one or more pieces of information registered in the storage unit as selectable items when the user inputs the message.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a recording medium such as a compact disc-read-only memory (CD-ROM) or DVD, and/or the memory of an FPGA or ASIC.

1. An information processing system, comprising:
an information processing apparatus; and
a terminal apparatus,
the information processing apparatus including processing circuitry configured to:
receive a message input by a user;
transmit the received message to artificial intelligence (AI);
receive a response generated by the AI to which the message has been transmitted;
cause information including the response to be displayed;
register the information in a memory in response to a predetermined instruction input by the user for the information;
cause one or more pieces of information, including the information including the response, registered in the memory to be displayed as selectable items in response to the message input by the user;
transmit to the terminal apparatus web content data for displaying:
a first web page including a screen for receiving input of the message from the user; and
a second web page enabling selectable display of the one or more pieces of registered information,
the web content data including a script that causes the terminal apparatus to execute at least:
a process for transmitting an instruction to retrieve the one or more pieces of registered information to the information processing apparatus, the instruction being input on the first web page; and
a process for displaying the second web page enabling the selectable display of the one or more pieces of registered information;
read the one or more pieces of registered information in response to a HyperText Transfer Protocol (HTTP) request transmitted from the terminal apparatus executing the script and including the instruction to retrieve the one or more pieces of registered information, the instruction being input on the first web page displayed on the terminal apparatus based on the web content data; and
transmit, as a response to the HTTP request, an HTTP response including the one or more pieces of registered information to the terminal apparatus to cause the terminal apparatus to execute the script and display the second web page, the terminal apparatus including terminal circuitry configured to:
display, on a display, the first web page including the screen for receiving the input of the message from the user;
execute the script to transmit the HTTP request;
receive the HTTP response; and
display, on the display, the second web page based on the one or more pieces of registered information included in the HTTP response.

2. The information processing system according to claim 1,
wherein the processing circuitry is configured to register, in the memory, information relevant to a part of the information including the response, the part being selected by the user.

3. The information processing system according to claim 1,
wherein the processing circuitry is configured to cause the response included in the information registered in the memory to be displayed in response to the message input by the user.

4. The information processing system according to claim 1,
wherein the processing circuitry is configured to cause a history to be displayed in response to the message input by the user, the history being a history of messages from the user and responses from the AI having been received until the AI generates the response for which the predetermined instruction is input.

5. The information processing system according to claim 1,
wherein the processing circuitry is configured to hierarchize or group the one or more pieces of information registered in the memory, based on user input.

6. The information processing system according to claim 1,
wherein the processing circuitry is configured to generate the information including the response.

7. The information processing system according to claim 1,
wherein the information including the response includes document data.

8. The information processing system according to claim 1,
wherein the processing circuitry is configured to:
generate a prompt including:
a piece of information selected by the user from the one or more pieces of information displayed as selectable items; and
the message input by the user; and
transmit the generated prompt to the AI.

9. An information processing method, comprising:
receiving a message input by a user;
transmitting the received message to AI;
receiving a response generated by the AI to which the message has been transmitted;
causing information including the response to be displayed;
registering the information in a memory in response to a predetermined instruction input by the user for the information;
causing one or more pieces of information, including the information including the response, registered in the memory to be displayed as selectable items in response to the message input by the user;
transmitting to a terminal apparatus web content data for displaying:
a first web page including a screen for receiving input of the message from the user; and
a second web page enabling selectable display of the one or more pieces of registered information,
the web content data including a script that causes the terminal apparatus to execute at least:
a process for transmitting an instruction to retrieve the one or more pieces of registered information to the information processing apparatus, the instruction being input on the first web page; and
a process for displaying the second web page enabling the selectable display of the one or more pieces of registered information;
reading the one or more pieces of registered information in response to an HTTP request transmitted from the terminal apparatus executing the script and including the instruction to retrieve the one or more pieces of registered information, the instruction being input on the first web page displayed on the terminal apparatus based on the web content data; and
transmitting, as a response to the HTTP request, an HTTP response including the one or more pieces of registered information to the terminal apparatus to cause the terminal apparatus to execute the script and display the second web page.

10. A terminal apparatus, comprising circuitry configured to:
receive a message input by a user;
display, on a display, information including a response from AI to the received message;
register the information in a memory in response to a predetermined instruction input by the user for the information; and
display one or more pieces of information, including the information including the response, registered in the memory on the display as selectable items in response to the message input by the user.
